(19) United States
(12) Patent Application Publication
(10) Pub. No.: US 2015/0306916 A1
(43) Pub. Date: Oct. 29, 2015

(54) PNEUMATIC VEHICLE TIRE FOR USE IN WINTER DRIVING CONDITIONS

(71) Applicant: Continental Reifen Deutschland GmbH, Hannover (DE)

(72) Inventors: Franz Diensthuber, Frankfurt (DE); Jan Schlittenhard, Wedemark (DE); Christian Brandau, Hannover (DE)

(21) Appl. No.: 14/794,442

(22) Filed: Jul. 8, 2015

Related U.S. Application Data
(63) Continuation of application No. PCT/EP2013/075737, filed on Dec. 6, 2013.

(30) Foreign Application Priority Data
Jan. 8, 2013 (DE) 10 2013 100 101.7

(51) Int. Cl. B60C 11/03; B60C 11/04; B60C 5/00

(52) U.S. Cl. CPC B60C 11/0311; B60C 5/00; B60C 11/04

(57) ABSTRACT

A pneumatic vehicle tire is for use in winter driving conditions and defines an axial direction (aR) and a circumferential direction (uR). The pneumatic vehicle tire includes a tread having a plurality of profile blocks. The profile blocks have sipes. The tread has two axially outwardly arranged shoulder regions and further has a central tread region arranged between the two shoulder regions. The profile blocks each have two profile block edges. The profile blocks each have a surface defining a plurality of grooves therein. The grooves are arranged in parallel and extend from one of the two profile block edges to the other one of the two profile block edges. The grooves are arranged approximately in the axial direction (aR) in the central tread region and approximately in the circumferential direction (uR) in the shoulder regions.

### CROSS REFERENCE TO RELATED APPLICATIONS

This application is a continuation application of international patent application PCT/EP2013/075737, filed Dec. 6, 2013, designating the United States and claiming priority from German application 10 2013 100 101.7, filed Jan. 8, 2013, and the entire content of both applications is incorporated herein by reference.

### FIELD OF THE INVENTION

The invention relates to a pneumatic vehicle tire for use in winter driving conditions, having a tread, which has profile blocks having sipes, and wherein the tread has two axially outwardly arranged shoulder regions and a central tread region arranged between the shoulder regions.

### BACKGROUND OF THE INVENTION

Especially passenger car and van tires for use in winter have a tread with sipes as described above. The sipes are used to ensure the gripping properties of the tire in winter driving conditions and, at the same time, to ensure good running characteristics and good handling properties on dry and wet roads.

One of the properties of the sipes in winter tires is that of receiving snow in winter conditions in order to increase the snow/snow friction and in this way to allow better adhesion of the tire on winter roads. Moreover, a multiplicity of edges is made available, which can dig into the winter road and ensure the necessary traction. The sipes usually have a width of 0.3 mm to 0.7 mm, a certain spacing with respect to one another and a radial extent of about 7 mm.

However, there is still a need for improvement as regards the traction properties.

### SUMMARY OF THE INVENTION

It is an object of the invention to provide a pneumatic vehicle tire for use in winter driving conditions which is improved in respect of its traction properties.

The object is achieved in that the surface of the profile blocks of the tread profile has grooves arranged parallel to one another, which extend from profile-block edge to profile-block edge, and in that the grooves are arranged approximately in an axial direction in the central tread region and in that the grooves are arranged approximately in a circumferential direction in the shoulder regions.

According to the invention, a pneumatic vehicle tire for use in winter driving conditions having a tread which, in addition to the sipes, has grooves on the surface of the profile blocks is provided. In the central tread region, the grooves are arranged approximately in an axial direction and improve the tread region in respect of traction in the presence of longitudinal forces. This is because the grooves of the profile blocks of the central tread region are arranged transversely, at an angle of about 90° to the longitudinal forces.

In the two shoulder regions, the grooves are arranged approximately in the circumferential direction of the tire and improve the tread region in respect of traction in the presence of transverse forces. This is because the grooves of the profile blocks of the shoulder regions are arranged transversely, at an angle of about 90° to the transverse forces.

In general, the central tread region is subject to higher stress in respect of circumferential forces (longitudinal forces), while the shoulder regions are subject to higher stress in respect of transverse forces.

The pneumatic vehicle tire for use in winter driving conditions is improved in respect of its traction properties.

“Axial direction” refers to the direction along the tire axis.

“Circumferential direction” refers to the direction of tire or tread rolling.

“Radial direction” refers to the direction from the center of the tire to the tread. It is advantageous if a groove has a radial extent of 0.2 mm to 0.5 mm, preferably of 0.2 mm.

It is advantageous if a groove has a width of 0.2 mm to 0.4mm, preferably of 0.2 mm.

It is expedient if two adjacent grooves have a spacing of 1 mm to 2 mm, preferably of 1 mm.

In one particular embodiment—in a plan view of the tread—the grooves are arranged crosswise relative to the sipes.

It is advantageous if—in a plan view of the tread—the sipes are sinusoidal sipes.

It is expedient if the grooves are arranged only within the ground contact surface of the pneumatic vehicle tire.

The pneumatic vehicle tire is preferably a passenger car or van tire.

### BRIEF DESCRIPTION OF THE DRAWINGS

The invention will now be described with reference to the drawings wherein:

FIG. 1 shows a plan view of a segment of a tread of a pneumatic vehicle tire according to the invention for use in winter driving conditions; and,

FIG. 2 shows a section A-A through the tread in FIG. 1.

### DESCRIPTION OF THE PREFERRED EMBODIMENTS OF THE INVENTION

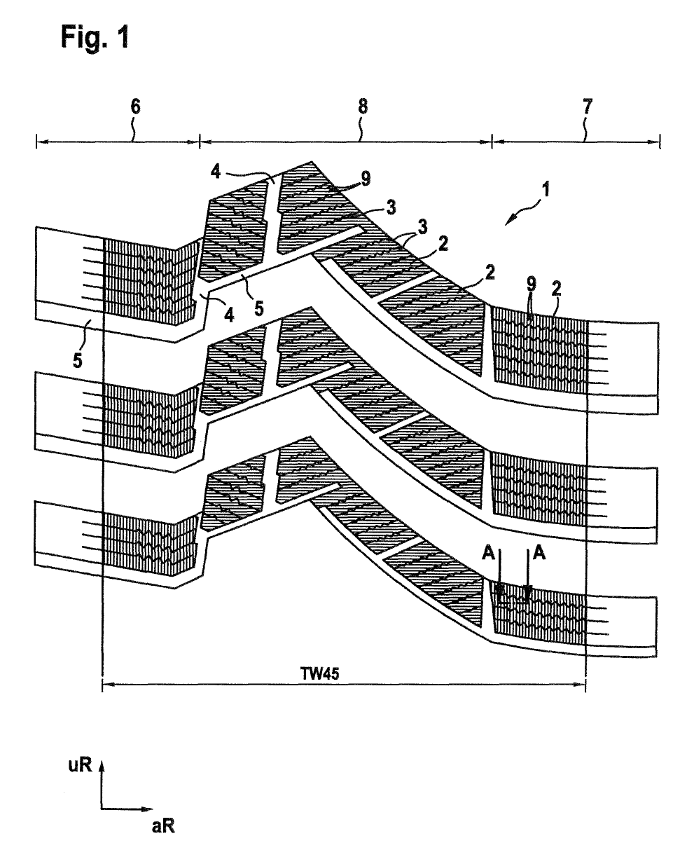

FIG. 1 shows a plan view of a segment of a tread 1 of a pneumatic vehicle tire according to the invention for use in winter driving conditions. The tread 1 has profile blocks 2 having sipes 3. The profile blocks 2 are bounded by circumferential channels 4 and transverse channels 5. The tread 1 has two axially outwardly arranged shoulder regions (6, 7) and a central tread region 8 arranged between the shoulder regions. The surface of the profile blocks 2 has grooves 9 arranged parallel to one another, which extend from profile-block edge to profile-block edge. The grooves 9 are arranged approximately in an axial direction aR in the central tread region 8. In the shoulder regions (6, 7), the grooves 9 are arranged approximately in a circumferential direction uR. The sipes 3 are sinusoidal sipes and are arranged crosswise relative to the grooves 9. The grooves 9 are formed only within the ground contact surface (TW45) of the tire.

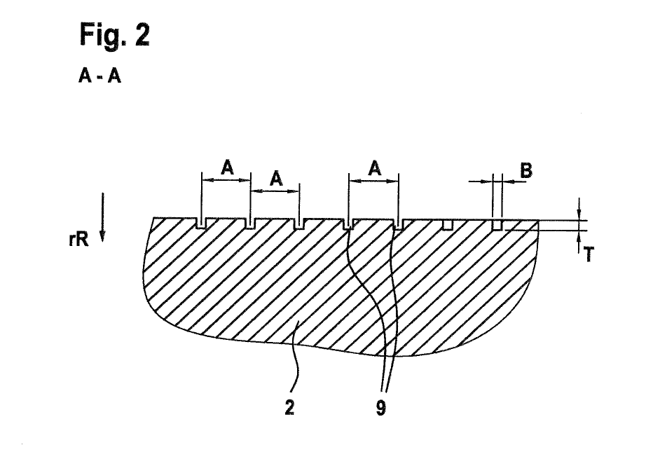

FIG. 2 shows a section A-A through the tread in FIG. 1. This section intersects the grooves 9 approximately at an angle of 90°. Identical components in FIG. 1 and FIG. 2 are identified by identical reference numerals. A groove 9 has a width B and a depth T of in each case 0.2 mm. Two adjacent grooves 9 have a spacing A of 1 mm.

It is understood that the foregoing description is that of the preferred embodiments of the invention and that various changes and modifications may be made thereto without departing from the spirit and scope of the invention as defined in the appended claims.

### LIST OF REFERENCE SIGNS

### Part of the Description

1 tread
2 profile block
3 sipe
4 circumferential channel
5 transverse channel
6 shoulder region
7 shoulder region
8 central tread region
9 groove
A spacing between two adjacent grooves
B width of a groove
T depth of a groove
rR radial direction
aR axial direction
uR circumferential direction

What is claimed is:

1. A pneumatic vehicle tire for use in winter driving conditions and defining an axial direction (aR) and a circumferential direction (uR), the pneumatic vehicle tire comprising:
a tread having a plurality of profile blocks;
said profile blocks having sipes;
said tread having two axially outwardly arranged shoulder regions;
said tread further having a central tread region arranged between said two shoulder regions;
said profile blocks each having two profile block edges;
said profile blocks each having a surface defining a plurality of grooves therein;
said grooves being arranged in parallel and extending from one of said two profile block edges to the other one of said two profile block edges; and,
said grooves being arranged approximately in the axial direction (aR) in said central tread region and approximately in the circumferential direction (uR) in said shoulder regions.

2. The pneumatic vehicle tire of claim 1, wherein said grooves have a radial extent (T) lying in a range from 0.2 mm to 0.4 mm.

3. The pneumatic vehicle tire of claim 1, wherein said grooves have a radial extent (T) of 0.2 mm.

4. The pneumatic vehicle tire of claim 1, wherein said grooves have a width (B) lying in a range from 0.2 mm to 0.4 mm.

5. The pneumatic vehicle tire of claim 1, wherein said grooves have a width (B) of 0.2 mm.

6. The pneumatic vehicle tire of claim 1, wherein mutually adjacent ones of said grooves have a spacing from each other lying in a range of 1 mm to 2 mm.

7. The pneumatic vehicle tire of claim 1, wherein mutually adjacent ones of said grooves have a spacing from each other of 1 mm.

8. The pneumatic vehicle tire of claim 1, wherein said grooves are arranged crosswise with respect to said sipes when said tread is viewed in plan.

9. The pneumatic vehicle tire of claim 1, wherein said sipes are sinusoidal sipes when said tread is viewed in plan.

10. The pneumatic vehicle tire of claim 1, wherein the vehicle tire defines a ground contact surface and said grooves are arranged only within the ground contact surface.

11. The pneumatic vehicle tire of claim 1, wherein the pneumatic vehicle tire is a passenger car tire or a van tire.
